(19) United States
(12) Patent Application Publication
(10) Pub. No.: US 2016/0016572 A1
(43) Pub. Date: Jan. 21, 2016

(54) Brake Control Device

(71) Applicant: HITACHI AUTOMOTIVE SYSTEMS, LTD., Ibaraki (JP)

(72) Inventor: Toshihiko HIGASHI, Atsugi-shi, Kanagawa (JP)

(73) Assignee: HITACHI AUTOMOTIVE SYSTEMS, LTD., Ibaraki (JP)

(21) Appl. No.: 14/773,196

(22) PCT Filed: Feb. 26, 2014
(86) PCT No.: PCT/JP2014/054625

§ 371 Date: Sep. 4, 2015

(30) Foreign Application Priority Data
Mar. 5, 2013 (JP) 2013-042675

(51) Int. Cl. B60T 13/68; B60T 8/40; B60T 13/16; B60T 7/04

(52) U.S. Cl. CPC B60T 13/686; B60T 7/042; B60T 8/4086; B60T 13/161

(57) ABSTRACT

Provided is a brake control device capable of preventing increases in device size and cost. A brake control device according to the present invention is arranged between a tandem master cylinder and wheel cylinders and equipped with primary and secondary brake circuit systems, only one of the brake circuit systems has not only a gate-out valve and a pump but also a brake circuit with a control valve. A master cylinder pressure in each fluid pressure chamber of the tandem master cylinder is adjusted by control of the gate-out valve, the pump and the control valve in accordance with driver's brake pedal operation.

### FIELD OF THE INVENTION

The present invention relates to a brake control device arranged between a master cylinder and wheel cylinders.

### BACKGROUND ART

There is known a technique of controlling the fluid pressures of wheel cylinders by pumping a brake fluid out from a master cylinder. Patent Document 1 discloses one such technique in which primary and secondary brake hydraulic systems have respective control valves to control the amount of flow of the brake fluid in fluid paths between the master cylinder and the suction side of the pump.

### PRIOR ART DOCUMENTS

### Patent Document

Patent Document 1: Japanese Laid-Open Patent Publication No. 2012-51455

### SUMMARY OF THE INVENTION

### Problem to be Solved by the Invention

In Patent Document 1, however, the arrangement of control valves in the respective hydraulic systems leads to increases in the number of control valves and the number of controlled components. There thus arises a problem of increases in device size and cost.

It is accordingly an object of the present invention to provide a brake control device capable of preventing increases in device size and cost.

### Means for Solving the Problem

As a solution to the above problem, the present invention provides a brake control device arranged between a tandem master cylinder and wheel cylinders and equipped with primary and secondary brake hydraulic systems, each of which has a gate-out valve and a pump and only one of which has a brake circuit with a control valve, to adjust a master cylinder pressure in each fluid pressure chamber of the tandem master cylinder by control of the gate-out valve, the pump and the control valve in accordance with driver's brake pedal operation.

### Effects of the Invention

In the present invention, the master cylinder pressure can be properly adjusted even though the brake circuit with the control valve is provided in either one of the hydraulic systems. It is therefore possible to limit the number of brake circuits and control valves and prevent increases in the size and cost of the brake control device.

### BRIEF DESCRIPTION OF DRAWINGS

FIG. 1 is a hydraulic circuit diagram of a brake control device according to a first embodiment of the present invention.

FIG. 2 is a flowchart of control process of the brake control device according to the first embodiment of the present invention.

FIG. 3 is a time chart showing the operation state of the brake control device at the time changeover from frictional braking mode to regenerative braking mode according to the first embodiment of the present invention.

FIG. 4 is a schematic view showing the operations of brake circuits of the brake control device at the time of changeover from the frictional braking mode to the regenerative braking mode.

FIG. 5 is a time chart showing the operation state of the brake control device at the time of changeover from regenerative braking mode to frictional braking mode according to the first embodiment of the present invention.

FIG. 6 is a schematic view showing the operations of brake circuits of the brake control device at the time of changeover from the regenerative braking mode to the frictional braking mode.

### DESCRIPTION OF EMBODIMENTS

### First Embodiment

[Brake Hydraulic Circuit Configuration]

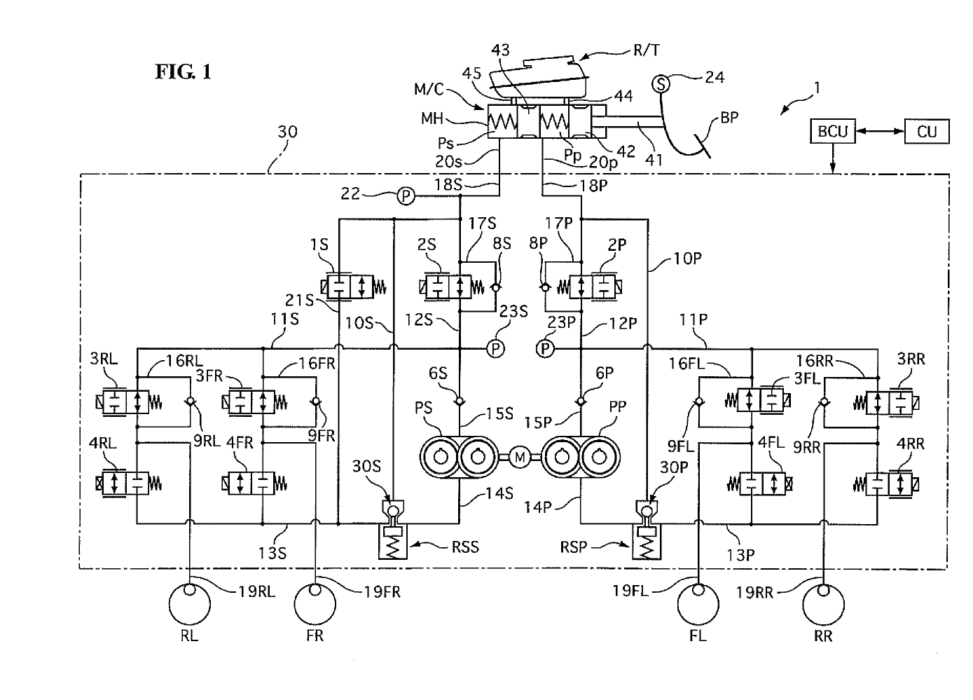

FIG. 1 is a hydraulic circuit diagram of a brake control device according to a first embodiment of the present invention.

In the brake control device, a fluid pressure control unit 30 is formed as a hydraulic circuit module between a master cylinder M/C and wheel cylinders W/C.

The master cylinder M/C is in the form of a tandem master cylinder equipped with a reservoir tank R/T and incorporating in its housing a first piston 43 movable together with a push rod 41, which is connected to a brake pedal BP, and a second piston 43 connected to the first piston 43 via an elastic member. There are a primary fluid pressure chamber Pp defined by the first piston 43 and the second piston 43 and a secondary fluid pressure chamber Ps defined by the second piston 43 and the master cylinder housing MH. As the first piston 43 and the second piston 43 are connected to each other via the elastic member, the primary and secondary fluid pressure chambers Pp and Ps are set to the same pressure.

A primary port 44 and a secondary port 25 are formed between the master cylinder housing MH and the reservoir tank R/T for communication from the reservoir tank R/T to the primary fluid pressure chamber Pp and the secondary fluid pressure chamber Ps, respectively. In a state where the brake pedal BP is not depressed, each of the fluid pressure chambers Pp and Ps is in communication with the reservoir tank R/T. When the brake pedal PB is depressed, the first piston 43 is moved to the left side of FIG. 1 so as to close the primary port 44 and thereby increase the fluid pressure in the primary fluid pressure chamber Pp. With the increase of the fluid pressure in the primary fluid pressure chamber Pp, the second piston 43 is also moved to the left side of FIG. 1 so as to close the secondary port 45 and thereby increase the fluid pressure in the secondary fluid pressure chamber Ps. In this tandem master cylinder, the position of the second piston 43 is changed such that the pressures in the primary and secondary fluid pressure chambers Pp and Ps become the same pressure.

A stroke sensor 24 is connected to the brake pedal BP so as to detect the stroke amount of the brake pedal and sense driver's braking intention.

In the first embodiment, the brake fluid pressure control device performs hydraulic control according to a hydraulic pressure demand for Vehicle Dynamics Control (VDC) or Anti-lock Brake System (ABS) of a brake controller BCU and according to a hydraulic pressure demand for regenerative cooperation control of an integrated vehicle drive controller CU.

The fluid pressure control unit 30 has a so-called X-split circuit layout formed with two brake hydraulic systems: a primary brake hydraulic system (hereinafter also referred to as “P hydraulic system”) and a secondary brake hydraulic system (hereinafter also referred to as “S hydraulic system”). The front left wheel cylinder W/C(FL) and the rear right wheel cylinder WC(RR) are connected to the P hydraulic system, whereas the front right wheel cylinder W/C(FR) and the rear left wheel cylinder W/C(RL) are connected to the S hydraulic system. The fluid pressure control unit 30 and the wheel cylinders W/C are connected to wheel cylinder ports 19 (19RL, 19FR, 19FL and 19RR) formed in an upper surface of a housing. Gear pumps PP and PS (sometimes generically referred to as “gear pumps P”) are disposed in the P and S hydraulic systems, respectively, as a tandem gear pump unit and are each driven by a motor M.

The fluid pressure control unit 30 and the master cylinder M/C are connected to fluid paths 18P and 18S through master cylinder ports 20p and 20s that are formed in a port connection surface of the housing. The fluid paths 18 are connected to the suction sides of the gear pumps P by fluid paths 10P and 10S. A master cylinder pressure sensor 22 is disposed on a part of the fluid path 18P between the master cylinder port 20p and the junction of the fluid paths 10P and 18P.

Fluid paths 15P and 15S are connected to the discharge sides of the gear pumps P. The wheel cylinders W/C are connected to the fluid paths 15P and 15S by fluid paths 11P and 11S. Fluid pressure sensors 23P and 23S are disposed on the fluid paths 15P and 15S so as to detect the discharge pressures of the gear pumps P (or the pressures in the wheel cylinders). Pressure boosting valves 3FL, 3RR, 3FR and 3RL (sometimes generically referred to as “pressure boosting valves 3”), each of which is in the form of a normally open type solenoid valve, are arranged on the respective fluid paths 11. Check valves 6P and 6S are arranged on parts of the fluid paths 15 between the pressure boosting valves 3 and the gear pumps P. Each of the check valve 6 is configured to permit flow of the brake fluid in a direction from the gear pump P to the pressure boosting valves 3 but prevent flow of the brake fluid in an opposite direction.

Fluid paths 16FL, 16RR, 16FR and 16RL are connected to the fluid paths 11 so as to bypass the pressure boosting valves 3. Check valves 9FL, 9RR, 9FR and 9RL are arranged on the respective fluid paths 16. Each of the check valves 9 is configured to permit flow of the brake fluid in a direction from the wheel cylinder W/C to the master cylinder M/C but prevent flow of the brake fluid in an opposite direction.

The master cylinder M/C is connected to the fluid paths 11 by fluid paths 12P and 12S. Herein, the junctions of the fluid paths 11 and 12 are located between the gear pumps P and the pressure boosting valves 3. Gate-out valves 2P and 2S (sometimes generically referred to as “gate-out valves 2”), each of which is in the form of a normally open type solenoid valve, are arranged on the respective fluid paths 12. Fluid paths 17P and 17S are connected to the fluid paths 12 so as to bypass the gate-out valves 2. Check valves 8P and 8S are arranged on the respective fluid paths 12. Each of the check valves 8 is configured to permit flow of the brake fluid in a direction from the wheel cylinders W/C to the master cylinder M/C but prevent flow of the brake fluid in an opposite direction.

Reservoirs RSP and RSS are disposed on the suction sides of the gear pumps P. The reservoirs RS and the gear pumps P are connected to each other by fluid paths 14P and 14S. The reservoirs RS and the wheel cylinders W/C are connected to each other by fluid paths 13P and 13S. Check valves 30P and 30S are arranged on the reservoirs PS so as to disconnect the fluid paths 10 from the fluid paths 13 and 14. Herein, the junctions of the fluid paths 13 and 14 are located at positions closer to the reservoirs RS than to the check valves 30 (i.e. downstream sides when viewed from the master cylinder). Pressure reducing valves 4FL, 4RR, 4FR and 4RL (sometimes generically referred to as “pressure reducing valves 4”), each of which is in the form of a normally closed type solenoid valve, are arranged on the respective fluid paths 13.

Further, a fluid path 21S (as a third brake circuit) is provided so as to connect the fluid path 18S (as a first brake circuit), which is located between the secondary fluid pressure chamber Ps and the gate-out valve 2S, to the fluid path 13S, which is located on the suction side of the gear pump PS. A suction valve 1S is arranged on the fluid path 21S and configured to adjust the master cylinder pressure by suction of the brake fluid from the secondary fluid pressure chamber Ps. The fluid path 21S with the suction valve 1S is provided only in the secondary brake hydraulic system and is not provided in the primary brake hydraulic system. It is thus possible to simplify the configuration of fluid paths and reduce the number of valve members.

The reason for arrangement of the fluid path 21S in the secondary brake hydraulic system rather than in the primary brake hydraulic system will be explained below.

In the first embodiment, the master cylinder M/C is of tandem type so that the second piston 43 is moved to eliminate a difference in fluid pressure between the primary and secondary fluid pressure chambers Pp and Ps as mentioned above. If a suction valve is provided only in the primary brake hydraulic system, the master cylinder pressure is adjusted to a target master cylinder pressure by flow of the brake fluid from the primary fluid pressure chamber Ps. In such a case, however, there is a possibility that the secondary port 45 may be opened upon movement of the second piston 43 to the right side of FIG. 1 with decrease in the volume of the primary fluid pressure chamber Pp. This results in a fluid pressure leak from the secondary brake hydraulic system. When the brake fluid is fed out from the secondary fluid pressure chamber Ps to the secondary brake hydraulic system, on the other hand, the first and second pistons 43 and 43 are moved together to the left side of FIG. 1 so that there is no possibility of communication of the master cylinder ports with the respective brake circuit systems.

For the above reasons, the suction valve 1S is provided only in the secondary brake hydraulic system in the first embodiment.

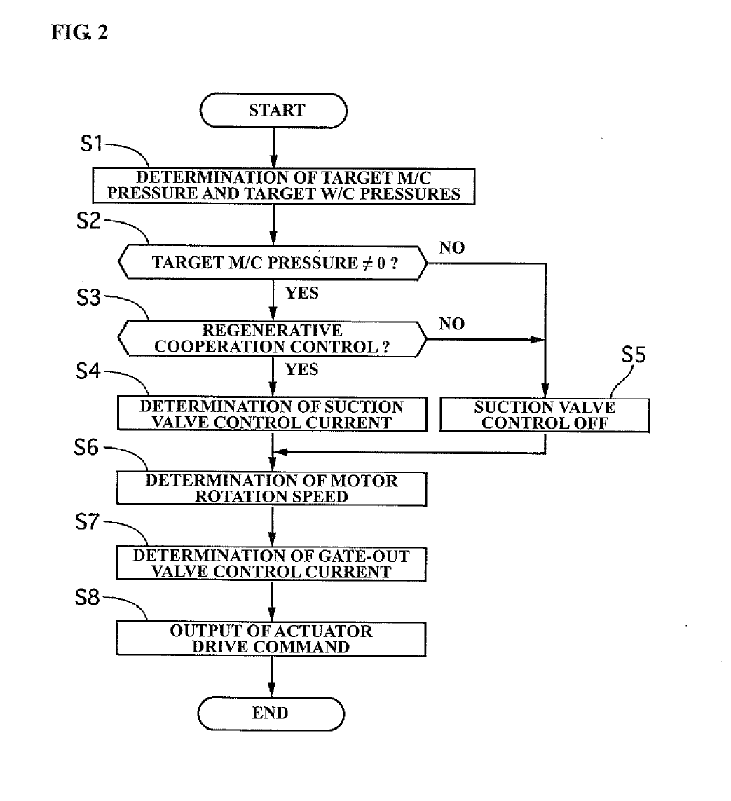

FIG. 2 is a flowchart of control process of the brake control device according to the first embodiment.

At step S1, the target master cylinder pressure and the target wheel cylinder pressures are determined based on the brake pedal stroke amount detected by the stroke sensor 24.

At step S2, it is judged whether the target master cylinder pressure is any value other than zero. When the target master cylinder pressure is any value other than 0, the process goes to step S3. When the target master cylinder pressure is 0, the process goes to step S5 to turn off the control of the suction valve 1S. It is because, when there is no need to adjust the master cylinder pressure, it is unnecessary to open and close the suction valve 1S.

As step S3, it is judged whether the regenerative cooperation control is in execution or not. When the regenerative cooperation control is in execution, the process goes to step S4 to determine the control current of the suction valve 1S. In the other case, the process goes to step S5 to turn off the control of the suction valve 1S. It is because, during servo control operation where the regenerative cooperation control is not in execution, the master cylinder pressure and the wheel cylinder pressures are adjusted by balance control of the gate-out valves 2 so that it is unnecessary to use the suction valve 1S in the first embodiment.

At step S4, the control current of the suction valve 1S is determined by the following procedure.

When the detection value of the master cylinder pressure sensor 22 is lower than the target master cylinder pressure, the control current is determined so as to drive the suction valve 1S in a valve closing direction. When the detection value of the master cylinder pressure sensor 22 is higher than the target master cylinder pressure, the control current is determined so as to drive the suction valve 1S in a valve opening direction. The amount of increase or decrease of the control current is set according to a pressure difference between the target master cylinder pressure and the actual master cylinder pressure.

As step S5, the control of the suction valve 1S is turned off.

As step S6, the rotation speed of the motor is determined based on the target wheel cylinder pressures. More specifically, the rotation speed of the motor is decreased when the detection value of the fluid pressure sensor 23 is higher than the highest value among the target wheel cylinder pressures. (When the motor rotation speed has been set to its minimum rotation speed, the motor rotation speed is maintained at the minimum rotation speed.) The rotation speed of the motor is increased when the detection value of the fluid pressure sensor 23 is lower than the highest value among the target wheel cylinder pressures.

At step S7, the control current of the gate-out valve 2 is determined. More specifically, the control current is determined so as to drive the gate-out valve 2 in a valve opening direction when the detection value of the fluid pressure sensor 23 is higher than the highest value among the target wheel cylinder pressures. The control current is determined so as to drive the gate-out value 2 in a valve closing direction when the detection value of the fluid pressure sensor 23 is lower than the highest value among the target wheel cylinder pressures. The amount of increase or decrease of the control current is set according to a difference between the highest target wheel cylinder pressure and the actual wheel cylinder pressure.

As step 8, drive commands are outputted to the respective actuators.

(Changeover from Frictional Braking Mode to Regenerative Braking Mode)

Next, the effects of the above flowchart process will be explained separately for each case.

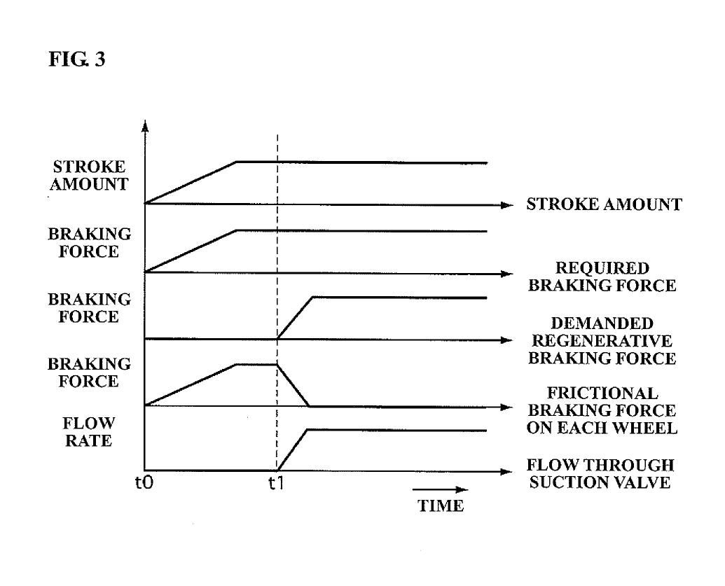

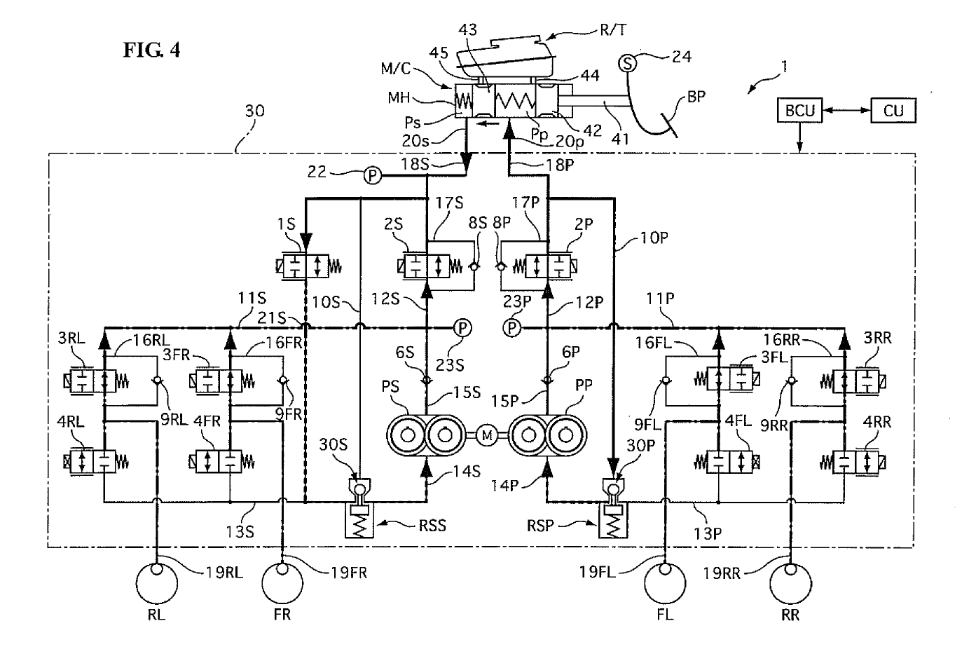

FIG. 3 is a time chart showing the operation state of the brake control device at the time of changeover from frictional braking mode to regenerative braking mode in the first embodiment. FIG. 4 is a schematic view showing the operations of the brake circuits at the time of changeover from the frictional braking mode to the regenerative braking mode.

The stroke amount of the brake pedal BP is increased when the driver's brake pedal operation is initiated at time t0. The required braking force increases with increase in the stroke amount of the brake pedal BP. Both of the target master cylinder pressure and the target wheel cylinder pressures also increase with increase in the stroke amount of the brake pedal BP. As the regenerative braking control is not yet in execution at this time, the servo control operation is performed so as to secure the pressure difference between the master cylinder pressure and the wheel cylinder pressures by balance control of the gate-out valves 2.

When the regenerative braking force is demanded at time t1, the brake fluid is returned from the wheel cylinders W/C to the master cylinder side through the gate-out valves 2 (see alternate long and short dash line arrows toward the gate-out valves 2 in FIG. 4) so as to decrease the frictional braking force. Under such hydraulic control, the suction valve 1S is opened so as to feed the brake fluid out from the secondary fluid pressure chamber Ps to the pump suction side (see a solid line arrow toward the suction valve 1S and a dashed line arrow from the suction valve 1S to the reservoir RS and to the gear pump PS in FIG. 4) and thereby avoid increase of the master cylinder pressure. The second piston 43 is then moved to the left side of FIG. 4 (see a left arrow along the master cylinder M/C in FIG. 4) while balancing between the pressures in the primary and secondary fluid pressure chambers Pp and Ps. As a result, the redundant brake fluid flows from the primary fluid pressure chamber Pp into the secondary brake hydraulic system through the master cylinder M/C. The master cylinder pressure can be thus adjusted to the target master cylinder pressure.

(Changeover from Regenerative Braking Mode to Frictional Braking Mode)

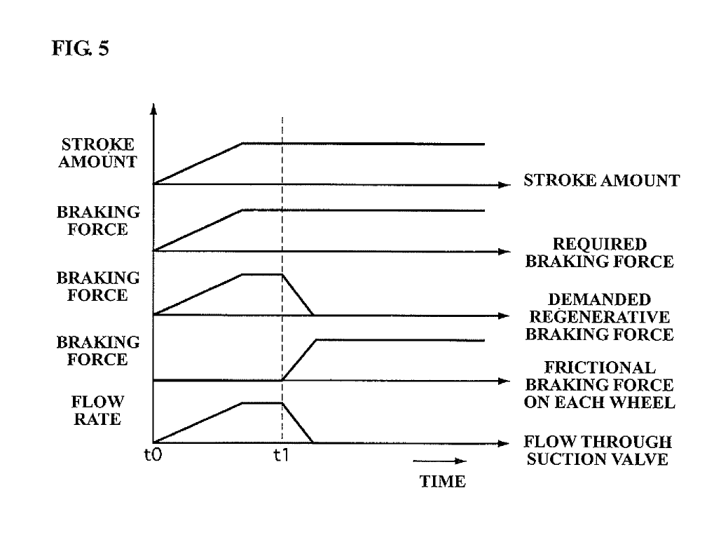

FIG. 5 is a time chart showing the operation state of the brake control device at the time of changeover from regenerative braking mode to frictional braking mode in the first embodiment. FIG. 4 is a schematic view showing the operations of the brake circuits at the time of changeover from the regenerative braking mode to the frictional braking mode.

The stroke amount of the brake pedal BP is increased when the driver's brake pedal operation is initiated at time t0. The required braking force increases with increase in the stroke amount of the brake pedal BP. The target master cylinder pressure also increases with increase in the stroke amount of the brake pedal BP. As the regenerative braking control is in execution at this time, the target wheel cylinder pressures do not increase so that there occurs no flow of the brake fluid from the master cylinder side to the wheel cylinder side. Under such hydraulic control, the suction valve 1S is opened so as to feed the brake fluid out from the secondary fluid pressure chamber Ps. The master cylinder pressure can be thus adjusted to the target master cylinder pressure.

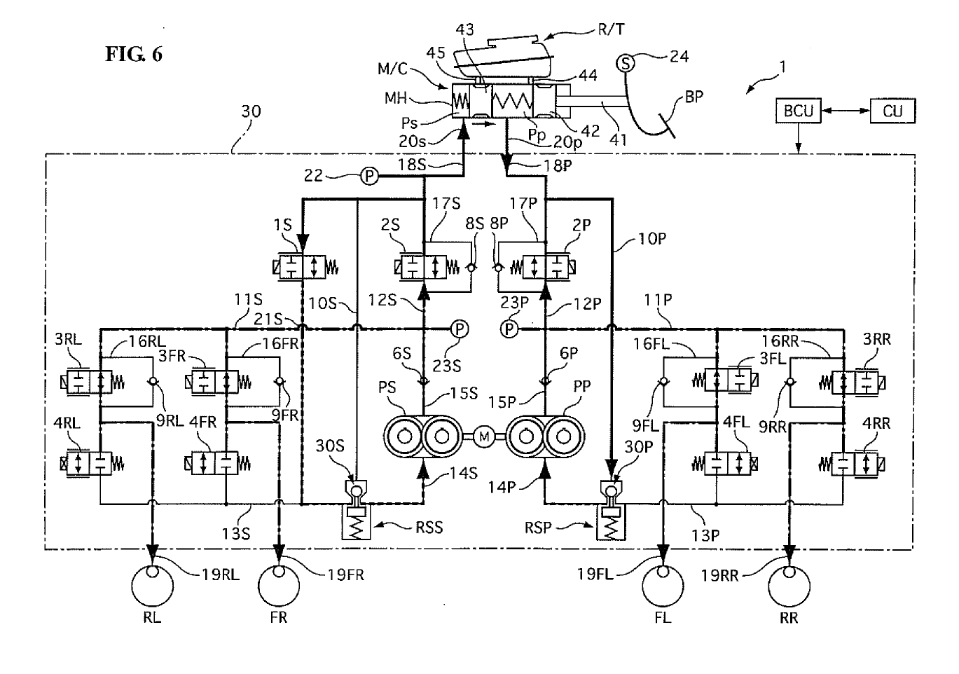

When the regenerative braking control is terminated at time t1, the brake fluid in the primary fluid pressure chamber Pp is fed to the wheel cylinder side (see an arrow from the primary fluid pressure chamber Pp in FIG. 6) so as to increase the frictional braking force. However, the brake fluid has been sucked in the secondary brake hydraulic system so that the amount of the brake fluid in the primary brake hydraulic system becomes insufficient. The suction valve 1S is hence driven in the valve closing direction so as to feed the brake fluid back through the gate-out valve 2S (see an alternate long and short dash line arrow toward the gate-out valve 2S and a solid line arrow toward the secondary fluid pressure chamber Ps in FIG. 6) while maintaining the master cylinder pressure. The second piston 43 is then moved to the right side of FIG. 6 (see a right arrow along the master cylinder M/C in FIG. 6) with the increase of the brake fluid in the secondary fluid pressure chamber Ps. As a result, the brake fluid in the primary fluid pressure chamber Pp can be secured to feed the sufficient amount brake fluid to the wheel cylinders W/C while maintaining the master cylinder pressure.

As mentioned above, the fluid path 21S with the suction valve 1S is provided only in one of the brake hydraulic systems, i.e., the secondary brake hydraulic system for adjustment of the master cylinder pressure. There is not provided a fluid path with a suction valve in the other brake hydraulic system, i.e., the primary brake hydraulic system. By the utilization of the features of the master cylinder that the independent primary and secondary fluid pressure chambers Pp and Ps are always set to the same pressure, the amounts of the brake fluid in the respective hydraulic systems can be controlled just by adjustment of the fluid pressure in the secondary fluid pressure chamber Ps. It is accordingly possible to adjust the master cylinder pressure for both of the hydraulic systems by operation control of only one of the hydraulic systems.

The operations and effects of the first embodiment are summarized as follows.

(1) The brake control device is characterized in that:

the P hydraulic system (primary brake hydraulic system) and the S hydraulic system (secondary brake hydraulic system) are operable independently of each other to increase the fluid pressures of the wheel cylinders W/C by flow of the brake fluid from the respective primary and secondary fluid pressure chambers Pp and Ps of the master cylinder M/C (tandem master cylinder);

each of the hydraulic systems has: the gear pump P (pump) that pumps the brake fluid from the primary, secondary fluid pressure chamber Pp, Ps to generate the fluid pressures of the wheel cylinders W/C; the fluid path 18 (first brake circuit) that connects the master cylinder M/C to the wheel cylinders W/C; the fluid path 15 (second brake circuit) that connects the fluid path 18 to the discharge side of the gear pump P; and the gate-out valve 2 arranged on a part of the fluid path 18 closer to the master cylinder than the junction of the fluid paths 15 and 18;

either one of the hydraulic systems has: the fluid path 21 S (third brake circuit) that connects the suction side of the gear pump Ps to a part of the fluid path 18 between the secondary fluid pressure chamber Ps and the gate-out valve 2; and the suction valve 1S (control valve) arranged on the fluid path 21S; and

the brake control device has the step S4 (master cylinder pressure adjustment portion) that adjusts the master cylinder pressure in each of the fluid pressure chambers by control of the gate-out valve 2S, the gear pump P and the suction valve Si in accordance with the driver's operation of the brake pedal.

It is therefore possible to adjust the master cylinder pressure with a reduced number of fluid paths and valve members and prevent increases in device size and cost.

(2) The brake control device of the above configuration (1) is further characterized in that: the hydraulic system has: the fluid path 10S (fourth brake circuit) that connects, in parallel with the fluid path 21, the suction side of the gear pump P to a part of the fluid path 18 closer to the master cylinder than the gate-out valve 2S; the reservoir RSS disposed on a part of the fluid path 10S closer to the suction side of the gear pump P; the check valve 30S (pressure regulating valve) arranged to limit the amount of flow of the brake fluid into the reservoir RSS; the pressure boosting valve 3 (inflow valve) arranged on a part of the fluid path 8 between the wheel cylinders and the junction of the fluid paths 15 and 18; the fluid path 14 (fifth brake circuit) that connects the suction side of the gear pump P to a part of the fluid path 18 closer to the wheel cylinders than the pressure boosting valve 3; and the pressure reducing valve 4 (outflow valve) arranged on the fluid path 14.

It is possible in this configuration to control the fluid pressures of the wheel cylinders by means of the pressure boosting and reducing valves and feed the brake fluid from the wheel cylinders through the pressure reducing valves to the gear pump P.

(3) The brake control device of the above configuration (1) is further characterized in that: the fluid pressure chambers of the master cylinder MC are divided by the second piston 43 (piston) as the primary fluid pressure chamber on the brake pedal side and the secondary fluid pressure chamber on the other side; the secondary fluid pressure chamber Ps is connected to the one of the hydraulic systems; the brake control device has: the master cylinder pressure sensor 22 (first pressure detection portion) arranged on a part of the fluid path 18 between the secondary fluid pressure chamber Ps and the gate-out valve 2 in the one of the hydraulic systems to detect the fluid pressure; and the stroke sensor 24 (stroke detection portion) arranged to detect the stroke amount of the brake pedal as the driver's operation; and the step S4 controls the opening of the suction valve 1S in such a manner as to maintain a predetermined relationship between the detected fluid pressure and the detected stroke amount.

It is possible in this configuration to control the relationship of the pedal stroke amount and pedal depression force in accordance with predetermined characteristics and obtain good pedal feeling.

(4) The brake control device of the above configuration (3) is further characterized in that: the brake control device has the target master cylinder pressure determination portion that determines the target master cylinder pressure based on the detected stroke amount; and the step S4 (master cylinder pressure adjustment portion) increases the opening of the suction valve 1S when the detected fluid pressure is higher than the determined target master cylinder pressure.

It is possible in this configuration to obtain good pedal feeling.

(5) The brake control device of the above configuration (4) is further characterized in that the step S4 (master cylinder pressure adjustment portion) decreases the opening of the suction valve 1S when the detected fluid pressure is lower than the determined target master cylinder pressure.

It is possible in this configuration to obtain good pedal feeling.

(6) The brake control device of the above configuration (4) is further characterized in that the brake control device rotates and drives the gear pump P during increase of the amount of the driver's operation of the brake pedal.

It is possible in this configuration to obtain good pedal feeling.

(7) The brake control device of the above configuration (1) is further characterized in that:

the brake control device has the stroke sensor 24 (stroke detection portion) arranged to detect the stroke amount of the brake pedal as the driver's operation;

the hydraulic system has: the fluid path 10S (fourth brake circuit) that connects, in parallel with the fluid path 21, the suction side of the gear pump P to a part of the fluid path 18 closer to the master cylinder than the gate-out valve 2S; the reservoir RS disposed on a part of the fluid path 10S closer to the suction side of the gear pump P; the check valve 30S (pressure regulating valve) arranged to limit the amount of flow of the brake fluid into the reservoir RS; the pressure boosting valve 3 (inflow valve) arranged on a part of the fluid path 8 between the wheel cylinders and the junction of the fluid paths 15 and 18; the fluid path 14 (fifth brake circuit) that connects the suction side of the gear pump P to a part of the fluid path 18 closer to the wheel cylinders than the pressure boosting valve 3; and the pressure reducing valve 4 (outflow valve) arranged on the fluid path 14;

the brake control sensor has: the fluid pressure sensor 23 (second pressure detection portion) arranged on a part of the fluid path 18 or 15 between the pressure increasing valve 3, the gear pump P and the gate-out valve 2 to detect the fluid pressure; and the target wheel cylinder pressure determination portion that determines the target wheel cylinder pressure based on the detected stroke amount; and

the brake control device drives the gate-out valve in a valve opening direction when the determined target wheel cylinder pressure is lower than the fluid pressure detected by the fluid pressure sensor 22.

It is possible in this configuration to adjust not only the master cylinder pressure but also the wheel cylinder pressures.

(8) The brake control device of the above configuration (7) is further characterized in that, when the determined target wheel cylinder pressure is higher than the fluid pressure detected by the fluid pressure sensor 23, the brake control device drives the gate-out valve 2 in the valve closing direction and rotates and drives the gear pump P.

It is possible in this configuration to properly adjust not only the master cylinder pressure but also the wheel cylinder pressures.

(9) The brake control device is characterized in that:

the P hydraulic system (primary brake hydraulic system) and the S hydraulic system (secondary brake hydraulic system) are operable independently of each other to increase the fluid pressures of the wheel cylinders W/C by flow of the brake fluid from the respective primary and secondary fluid pressure chambers Pp and Ps of the master cylinder M/C (tandem master cylinder);

each of the hydraulic systems has: the gear pump P (pump) that pumps the brake fluid from the primary, secondary fluid pressure chamber Pp, Ps to generate the fluid pressures of the wheel cylinders W/C; the fluid path 18 (first brake circuit) that connects the master cylinder M/C to the wheel cylinders W/C; the fluid path 15 (second brake circuit) that connects the fluid path 18 to the discharge side of the gear pump P; and the gate-out valve 2 arranged on a part of the fluid path 18 closer to the master cylinder than the junction of the fluid paths 15 and 18;

only the secondary brake hydraulic system has: the fluid path 21S with the suction valve 1S (master cylinder pressure adjustment circuit mechanism) to adjust the master cylinder pressure in each of the fluid pressure chambers Pp, Ps in accordance with the driver's operation of the brake pedal.

It is therefore possible to adjust the master cylinder pressure with a reduced number of fluid paths and valve members and prevent increases in device size and cost.

(10) The brake control device of the above configuration (9) is further characterized in that the master cylinder pressure adjustment circuit mechanism has: the fluid path 21S (third brake circuit) that connects the suction side of the gear pump Ps to a part of the fluid path 18 between the secondary fluid pressure chamber Ps and the gate-out valve 2; and the suction valve 1S (control valve) arranged on the fluid path 21S.

It is possible in this configuration to adjust the master cylinder pressure by a simple circuit mechanism with one valve member and prevent increases in device size and cost.

(11) The brake control device of the above configuration (10) is further characterized in that: the brake control device has the step S4 (master cylinder pressure adjustment portion) that adjusts the master cylinder pressure in each of the fluid pressure chambers Pp and Ps by control of the gate-out valve 2S, the gear pump P and the suction valve S1 in accordance with the driver's operation of the brake pedal.

It is possible in this configuration to adjust the master cylinder pressure by simple control process.

(12) The brake control device of the above configuration (11) is further characterized in that: the secondary brake hydraulic system has: the fluid path 10S (fourth brake circuit) that connects, in parallel with the fluid path 21, the suction side of the gear pump P to a part of the fluid path 15 closer to the master cylinder than the gate-out valve 2S; the reservoir RS disposed on a part of the fluid path 10S closer to the suction side of the gear pump P; and the check valve 30S (pressure regulating valve) arranged to limit the amount of flow of the brake fluid into the reservoir RS; the brake control device has: the master cylinder pressure sensor 22 (first pressure detection portion) arranged on a part of the fluid path 15 between the secondary fluid pressure chamber Ps and the gate-out valve 2 in the secondary brake hydraulic system to detect the fluid pressure; and the stroke sensor 24 (stroke detection portion) arranged to detect the stroke amount of the brake pedal as the driver's operation; and the step S4 controls the opening of the suction valve 1S in such a manner as to maintain a predetermined relationship between the detected fluid pressure and the detected stroke amount.

It is possible in this configuration to obtain good pedal feeling.

(13) The brake control device of the above configuration (12) is further characterized in that: the brake control device has the target master cylinder pressure determination portion that determines the target master cylinder pressure based on the detected stroke amount; and the step S4 (master cylinder pressure adjustment portion) increases the opening of the suction valve 1S when the detected fluid pressure is higher than the determined target master cylinder pressure.

It is possible in this configuration to obtain good pedal feeling.

(14) The brake control device of the above configuration (12) is further characterized in that: the brake control device has the target master cylinder pressure determination portion that determines the target master cylinder pressure based on the detected stroke amount; and the step S4 (master cylinder pressure adjustment portion) increases the opening of the suction valve 1S when the detected fluid pressure is higher than the determined target master cylinder pressure.

It is possible in this configuration to obtain good pedal feeling.

(15) The brake control device of the above configuration (13) is further characterized in that the brake control device rotates and drives the gear pump P during increase of the amount of the driver's operation of the brake pedal.

It is possible in this configuration to obtain good pedal feeling.

(16) The brake control device of the above configuration (11) is further characterized in that: the brake control device has: the stroke sensor 24 (stroke detection portion) arranged to detect the stroke amount of the brake pedal as the driver's operation; the fluid pressure sensor 23 (second pressure detection portion) arranged on a part of the fluid path 18 or 15 between the pressure increasing valve 3, the gear pump P and the gate-out valve 2 to detect the fluid pressure; and the target wheel cylinder pressure determination portion that determines the target wheel cylinder pressure based on the detected stroke amount; and the brake control device drives the gate-out valve in a valve opening direction when the determined target wheel cylinder pressure is lower than the fluid pressure detected by the fluid pressure sensor 22.

It is possible in this configuration to adjust not only the master cylinder pressure but also the wheel cylinder pressures.

(17) The brake control device of the above configuration (11) is further characterized in that, when the determined target wheel cylinder pressure is higher than the fluid pressure detected by the fluid pressure sensor 23, the brake control device drives the gate-out valve 2 in the valve closing direction and rotates and drives the gear pump P.

It is possible in this configuration to properly adjust not only the master cylinder pressure but also the wheel cylinder pressures.

(18) The brake control device is characterized in that:

the P hydraulic system (primary brake hydraulic system) and the S hydraulic system (secondary brake hydraulic system) are operable independently of each other to increase the fluid pressures of the wheel cylinders W/C by flow of the brake fluid from the respective primary and secondary fluid pressure chambers Pp and Ps of the master cylinder M/C (tandem master cylinder);

each of the hydraulic systems has: the gear pump P (pump) that pumps the brake fluid from the primary, secondary fluid pressure chamber Pp, Ps to generate the fluid pressures of the wheel cylinders W/C; the fluid path 18 (first brake circuit) that connects the master cylinder M/C to the wheel cylinders W/C; the fluid path 15 (second brake circuit) that connects the fluid path 18 to the discharge side of the gear pump P; the gate-out valve 2 arranged on a part of the fluid path 18 closer to the master cylinder than the junction of the fluid paths 15 and 18; and the fluid path 21 S (third brake circuit) that connects the suction side of the gear pump Ps to a part of the fluid path 18 between the secondary fluid pressure chamber Ps and the gate-out valve 2;

either one of the hydraulic systems has the step S4 (master cylinder pressure adjustment function) that adjusts the master cylinder pressure in each of the fluid pressure chambers in accordance with the driver's operation of the brake pedal; and

the other of the hydraulic systems has no master cylinder pressure adjustment function.

It is therefore possible to adjust the master cylinder pressure with a reduced number of fluid paths and valve members and prevent increases in device size and cost.

(19) The brake control device of the above configuration (18) is further characterized in that: the hydraulic system has: the fluid path 10S (fourth brake circuit) provided in parallel with the fluid path 21S; the reservoir RS disposed on a part of the fluid path 10S closer to the suction side of the gear pump P; the check valve 30S (pressure regulating valve) arranged to limit the amount of flow of the brake fluid into the reservoir RS; and the suction valve 1S (control valve) arranged on the fluid path 10S; and the step S4 (master cylinder pressure adjustment function) drives the suction valve 1S in accordance with the driver's operation of the brake pedal to adjust the master cylinder pressure in each of the fluid pressure chambers Pp and Ps.

It is possible in this configuration to adjust the master cylinder pressure with a reduced number of fluid paths and valve members and prevent increases in device size and cost.

1. A brake control device, comprising: primary and secondary brake hydraulic systems operable independently of each other to increase fluid pressures of wheel cylinders by flow of brake fluid from respective fluid pressure chambers of a tandem master cylinder,
each of the brake hydraulic systems having:
a pump that pumps the brake fluid from the fluid pressure chamber to generate the fluid pressures of the wheel cylinders;
a first brake circuit that connects the master cylinder to the wheel cylinders;
a second brake circuit that connects the first brake circuit to a discharge side of the pump; and
a gate-out valve arranged on a part of the first brake circuit closer to the master cylinder than a junction of the first and second brake circuits,
either one of the brake hydraulic systems having:
a third brake circuit that connects a suction side of the pump to a part of the first brake circuit between the fluid pressure chamber and the gate-out valve; and
a control valve arranged on the third brake circuit,
the brake control device having a master cylinder pressure adjustment portion that adjusts a master cylinder pressure in each of the fluid pressure chambers by control of the gate-out valve, the pump and the control valve in accordance with driver's operation of a brake pedal.

2. The brake control device according to claim 1,
wherein said one of the brake hydraulic systems has:
a fourth brake circuit that connects, in parallel with the third brake circuit, the suction side of the pump to a part of the first brake circuit closer to the master cylinder than the gate-out valve;
a reservoir disposed on a part of the fourth brake circuit closer to the suction side of the pump;
a pressure regulating valve arranged to limit the amount of flow of the brake fluid into the reservoir;
an inflow valve arranged on a part of the first brake circuit between the wheel cylinders and the junction of the first and second brake circuits;
a fifth brake circuit that connects the suction side of the pump to a part of the first brake circuit closer to the wheel cylinders than the inflow valve; and
an outflow valve arranged on the fifth brake circuit.

3. The brake control device according to claim 1,
wherein the fluid pressure chambers of the master cylinder MC are divided by a piston as a brake-pedal-side fluid pressure chamber and an other-side fluid pressure chamber;
wherein said one of the brake hydraulic systems is connected to the other-side fluid pressure chamber;
wherein the brake control device has:
a first pressure detection portion arranged on a part of the first brake circuit between the other-side fluid pressure chamber and the gate-out valve in said one of the primary and secondary brake hydraulic systems to detect a fluid pressure; and
a stroke detection portion arranged to detect a stroke amount of the brake pedal as the driver's operation; and
wherein the master cylinder pressure adjustment portion controls an opening of the control valve in such a manner as to maintain a predetermined relationship between the detected fluid pressure and the detected stroke amount.

4. The brake control device according to claim 3,
wherein the brake control device has a target master cylinder pressure determination portion that determines a target master cylinder pressure based on the detected stroke amount; and
wherein the master cylinder pressure adjustment portion increases the opening of the control valve when the detected fluid pressure is higher than the determined target master cylinder pressure.

5. The brake control device according to claim 4,
wherein the master cylinder pressure adjustment portion decreases the opening of the control valve when the detected fluid pressure is lower than the determined target master cylinder pressure.

6. The brake control device according to claim 5,
wherein the brake control device rotates and drives the pump during increase of the driver's operation of the brake pedal.

7. The brake control device according to claim 1,
wherein the brake control device has a stroke detection portion arranged to detect a stroke amount of the brake pedal as the driver's operation;
wherein said one of the brake hydraulic systems has:
a fourth brake circuit that connects, in parallel with the third brake circuit, the suction side of the pump to a part of the first brake circuit closer to the master cylinder than the gate-out valve;
a reservoir disposed on a part of the fourth brake circuit closer to the suction side of the pump;
a pressure regulating valve arranged to limit the amount of flow of the brake fluid into the reservoir;
an inflow valve arranged on a part of the first brake circuit between the wheel cylinders and the junction of the first and second brake circuits;
a fifth brake circuit that connects the suction side of the pump to a part of the first brake circuit closer to the wheel cylinders than the inflow valve; and
an outflow valve arranged on the firth brake circuit;
wherein the brake control sensor has:
a second pressure detection portion arranged on a part of the first or second brake circuit between the inflow valve, the pump and the gate-out valve to detect a fluid pressure; and
a target wheel cylinder pressure determination portion that determines a target wheel cylinder pressure based on the detected stroke amount; and
wherein the brake control device drives the gate-out valve in a valve opening direction when the determined target wheel cylinder pressure is lower than the fluid pressure detected by the second pressure detection portion.

8. The brake control device according to claim 7,
wherein, when the determined target wheel cylinder pressure is higher than the fluid pressure detected by the second pressure detection portion, the brake control device drives the gate-out valve in a valve closing direction and rotates and drives the pump.

9. A brake control device, comprising: primary and secondary brake hydraulic systems operable independently of each other to increase fluid pressures of wheel cylinders by flow of brake fluid from respective fluid pressure chambers of a tandem master cylinder,
each of the primary and secondary brake hydraulic systems having:
a pump that pumps the brake fluid from the fluid pressure chamber to generate the fluid pressures of the wheel cylinders;
a first brake circuit that connects the master cylinder to the wheel cylinders;
a second brake circuit that connects the first brake circuit to a discharge side of the pump; and
a gate-out valve arranged on a part of the first brake circuit closer to the master cylinder than a junction of the first and second brake circuits,
only the secondary brake hydraulic system having a master cylinder pressure adjustment circuit mechanism that adjusts a master cylinder pressure in each of the fluid pressure chambers in accordance with driver's operation of a brake pedal.

10. The brake control device according to claim 9,
wherein the master cylinder pressure adjustment circuit mechanism has:
a third brake circuit connecting a suction side of the pump to a part of the first brake circuit between the fluid pressure chamber and the gate-out valve; and
a control valve arranged on the third brake circuit.

11. The brake control device according to claim 10,
wherein the brake control device has a master cylinder pressure adjustment portion that allows the master cylinder pressure adjustment circuit mechanism to adjust the master cylinder pressure in each of the fluid pressure chambers by control of the gate-out valve, the pump and the control valve in accordance with the driver's operation of the brake pedal.

12. The brake control device according to claim 11,
wherein the secondary brake hydraulic system has:
a fourth brake circuit that connects, in parallel with the third brake circuit, the suction side of the pump to a part of the second brake circuit closer to the master cylinder than the gate-out valve;
a reservoir disposed on a part of the fourth brake circuit closer to the suction side of the pump; and
a pressure regulating valve arranged to limit the amount of flow of the brake fluid into the reservoir;
wherein the brake control device has:
a first pressure detection portion arranged on a part of the second brake circuit between the fluid pressure chamber and the gate-out valve in the secondary brake hydraulic system to detect a fluid pressure; and
a stroke detection portion arranged to detect a stroke amount of the brake pedal as the driver's operation; and
wherein the master cylinder pressure adjustment portion controls an opening of the control valve in such a manner as to maintain a predetermined relationship between the detected fluid pressure and the detected stroke amount.

13. The brake control device according to claim 12,
wherein the brake control device has a target master cylinder pressure determination portion that determines a target master cylinder pressure based on the detected stroke amount; and
wherein the master cylinder pressure adjustment portion increases the opening of the control valve when the detected fluid pressure is higher than the determined target master cylinder pressure.

14. (canceled)

15. The brake control device according to claim 13,
wherein the brake control device rotates and drives the pump during increase of the driver's operation of the brake pedal.

16. The brake control device according to claim 11,
wherein the secondary brake hydraulic system has an inflow valve arranged on a part of the first brake circuit closer to the wheel cylinders;
wherein the brake control device has:
a stroke detection portion arranged to detect a stroke amount of the brake pedal as the driver's operation;
a second pressure detection portion arranged on a part of the first or second brake circuit between the inflow valve, the pump and the gate-out valve to detect a fluid pressure; and
a target wheel cylinder pressure determination portion that determines a target wheel cylinder pressure based on the detected stroke amount; and
wherein the brake control device drives the gate-out valve in a valve opening direction when the determined target wheel cylinder pressure is lower than the fluid pressure detected by the second pressure detection portion.

17. The brake control device according to claim 11,
wherein, when the determined target wheel cylinder pressure is higher than the fluid pressure detected by the second pressure detection portion, the brake control device drives the gate-out valve in a valve closing direction and rotates and drives the pump.

18. A brake control device, comprising: primary and secondary brake hydraulic systems operable independently of each other to increase fluid pressures of wheel cylinders by flow of brake fluid from respective fluid pressure chambers of a tandem master cylinder,
each of the brake hydraulic systems having:
a pump that pumps the brake fluid from the fluid pressure chamber to generate the fluid pressures of the wheel cylinders;
a first brake circuit that connects the master cylinder to the wheel cylinders;
a second brake circuit that connects the first brake circuit to a discharge side of the pump;
a gate-out valve arranged on a part of the first brake circuit closer to the master cylinder than a junction of the first and second brake circuits; and
a third brake circuit that connects a suction side of the pump to a part of the first brake circuit closer to the master cylinder than the gate-out valve,
wherein either one of the brake hydraulic systems has a master cylinder pressure adjustment function that adjusts a master cylinder pressure in each of the fluid pressure chambers in accordance with driver's operation of a brake pedal; and
wherein the other of the brake hydraulic systems has no master cylinder pressure adjustment function.

19. The brake control device according to claim 18,
wherein said one of the brake hydraulic systems has:
a fourth brake circuit provided in parallel with the third brake circuit;
a reservoir disposed on a part of the fourth brake circuit closer to the suction side of the pump;
a pressure regulating valve arranged to limit the amount of flow of the brake fluid into the reservoir; and
a control valve arranged on the fourth brake circuit; and
wherein the master cylinder pressure adjustment function drives the control valve in accordance with the driver's operation of the brake pedal to adjust the master cylinder pressure in each of the fluid pressure chambers.
